(19) United States
(12) Patent Application Publication
(10) Pub. No.: US 2007/0097025 A1
(43) Pub. Date: May 3, 2007

(54) LCD display

(76) Inventors: Tomoko Itoh, Osaka (JP); Katsuimi Horiguchi, Osaka (JP); Satoshi Deto, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,870

(22) Filed: Oct. 27, 2005

(51) Int. Cl. G09G 3/18

(52) U.S. Cl. 345/50

(57) ABSTRACT

The present invention is an LCD display unit, including an LCD display having a predetermined number of segments, a drive unit that drives the LCD display, a control unit that controls the drive unit to display the display information on the LCD display, and an operation unit for selecting display information displayed on the LCD display. The control unit normally displays the display information in an abbreviated form on the LCD display. When the display information is selected based upon operation of the operation unit the selected display information is displayed in full text form on the LCD display. When the length of the character string of the display information displayed in full text form exceeds the display range of the LCD display the display information is displayed as scrolled.

### FIELD OF THE INVENTION

The present invention relates to an LCD display unit used in many types of equipment including for example business equipment such as copiers, printers, facsimile machines.

### BACKGROUND INFORMATION

Display units are provided in business equipment such as copiers, printers, and facsimile machines for displaying information such as error messages. These display units can use liquid crystal displays (LCD), for example.

In order to reduce equipment size, space, and cost, this type of display unit uses as few segments as possible, so the number of characters that can be displayed is limited.

Therefore, when displaying specific information on these display units, abbreviated displays are normally used to keep the number of characters within the number that can be displayed.

On the other hand, conventionally there have been many proposed methods of controlling the contents displayed in the display units of image forming devices such as copiers.

For example, image forming devices including LCD display means are known in which the character size or layout is changed in accordance with the content of the display, in order to display the content in the display unit.

Also, operation devices are known in which the LCD display and lighting are turned off when operating in response to various controls and instructions.

However, the display units described above have the following problems.

In a display unit with few segments, for example an average 16 character display, abbreviated displays cannot correctly communicate the information to the user when displaying fault information or requests for maintenance, particularly when the user is not familiar with the content.

Therefore it is necessary for the user to refer to the instruction manual to determine the meaning of the abbreviated display, which complicates the operation.

In contrast to this in the above-mentioned operation devices, information with many characters can be displayed by making the character size smaller. However, in segmentalized displays such as LCD displays it is not possible to change the character size.

Also, in these operation devices, when it is not necessary to display information the display unit is turned off to conserve electricity and increase the life of the display unit, and abbreviated displays are not used.

It is an object of the present invention to solve the above problems and provide an LCD display unit that is capable of correctly communicating the necessary information to users.

### SUMMARY OF THE INVENTION

In order to achieve this object, the LCD display unit of claim 1 of the present invention includes LCD display means having a predetermined number of segments; drive means that drives the LCD display means; control means that controls the drive means to display one or a plurality of display information on the LCD display means; and operation means for selecting part or all of the one or a plurality of display information displayed on the LCD display means, wherein the control means normally displays a part or all of the one or a plurality of display information in an abbreviated form on the LCD display means; when the above display information is selected based upon operation of the operation means the selected display information is displayed in full text form on the LCD display means; and when the length of the character string of the display information displayed in full text form exceeds the display range of the LCD display means the display information is displayed as scrolled.

With an LCD display unit configured in this way, when a user operates the operation unit to select specific display information from among the one or a plurality of display information displayed on the LCD display means (for example, menu items, fault displays, maintenance requests, etc.), the control means displays the full text of the display information on the LCD display means. Therefore, the user can accurately understand the content of the display information by seeing the full text of the display information displayed on the LCD display means.

Furthermore, by displaying the full text of the display information it is not necessary for the user to refer to the instruction manual as is necessary with conventional abbreviated displays, and the content of the display information can be easily understood. In particular, even with display information with comparatively complicated contents, such as faults or maintenance requests, the intention of the display information can be correctly communicated to the user.

Moreover, when the length of the character string of the display information exceeds that which can be displayed in the LCD display unit the display information is scrolled, so that the full text of the display information can be displayed in the LCD display means with few segments. In this way the necessary information can be correctly communicated to the user.

On the other hand, when the user does not select the display information using the operation means, the control means displays the display information on the LCD display means in abbreviated form. In this way when the user has a high level of proficiency, the user can correctly understand the content of the display information even if it is in abbreviated form, without displaying the display information in full text form.

Also, in the LCD display unit according to claim 2, when the length of the character string of the display information displayed in full text form exceeds the display range of the LCD display means, the control means scrolls the display information after a predetermined period of time has passed after selecting the display information based upon operation of the operation means.

In an LCD display unit configured in this way, after display information has been selected by operating the operation means, the abbreviated form of the display information is displayed for a predetermined period or time. Therefore, by comparing the abbreviated text form with the full text form of the display information that is displayed subsequently, the user can associate and recognize the abbreviated form with the full text form. Therefore, when the proficiency of the user increases, the user can accurately understand the content of the display information when the user sees the abbreviated form displayed on the LCD display unit, without selecting the display information using the operation means.

Also, in the LCD display unit according to claim 3, the control means adds an identification symbol to the front and/or back of the display information being scrolled. In an LCD display unit configured in this way, a user can easily recognize the start and end of full text of the display information being scrolled on the LCD display unit. In this way even if, for example, the full text of the display information is scrolled repeatedly, a user can easily recognize the start and end of the display information, and can easily comprehend all the text.

Also, in the LCD display unit according to claim 4, when the display information is being scrolled, the control means enlarges each character of the display information in the vertical and/or horizontal direction by a predetermined factor.

In an LCD display unit configured in this way, when the display is being scrolled on the LCD display unit, a user can see characters enlarged by a predetermined factor (for example, double height and width characters), so even if the characters are moving due to the scrolling display each character can be easily read so the content of the full text of the display information can be easily comprehended.

Also, in the LCD display unit according to claim 5, when the display information is being scrolled, the control means scrolls the full text of the display information to the left by a predetermined number of dots at a time in each segment of the LCD display means.

In an LCD display unit configured in this way, when the display information is being shifted to the left by a predetermined number of dots at a time (for example, one dot at a time) on the LCD display unit, a user can easily read each character, so the full text of display information can be easily seen.

Also, in the LCD display unit according to claim 6, when the display information is being scrolled, the control means scrolls the full text of the display information upwards by a predetermined number of dots at a time in each segment of the LCD display means.

In an LCD display unit configured in this way, when the display information is being shifted upward a predetermined number of dots at a time (for example, one dot at a time) on the LCD display unit, a user can easily read each character, so the full text of display information can be easily seen.

Also, the LCD display unit according to claim 7 includes direction keys to specify the direction of scrolling the display information, and the control means scrolls the display information based upon the direction specified by the direction keys.

In an LCD display unit configured in this way, a user can scroll the display information on the LCD display unit in the direction they wish and at their own pace by operating the direction keys of the operation means, so that each character can be read properly. In addition, if a user wants to re-read the display it is possible to scroll in the reverse direction by operating the direction key for the opposite direction, so that the full text of the display information can be easily and accurately read.

Also, in the LCD display unit according to claim 8, when the operation time of a direction key is less than a predetermined period of time, the control means scrolls the full text of the display information one character at a time in the direction specified by the direction key.

In an LCD display unit configured in this way, when a user wants to read the display information slowly by operating the direction keys of the operation means, the direction keys are operated for a short period of time. The full text of the display information displayed on the LCD display unit is scrolled one character at a time, so that the full text of the display information can be easily and accurately read.

Also, in the LCD display unit according to claim 9, when the operation time of a direction key is longer than a predetermined period of time, the control means scrolls the full text of the display information continuously in the direction specified by the direction key.

In an LCD display unit configured in this way, when a user wants to read the display information in one go by operating the direction keys of the operation means, the direction keys are operated for a long period of time and the full text of the display information displayed on the LCD display unit is scrolled continuously and automatically, so that the full text of the display information can be easily and accurately read.

In this way, according to the present invention when specific display information is selected by a user, the control means does not display an abbreviated form of the text of display information whose number of characters exceeds that which can be displayed on the LCD display means, but scrolls the full text, so that the display information can be easily and accurately communicated to a user.

### BRIEF DESCRIPTION OF THE DRAWINGS

FIG. 1 is a block diagram showing the main configuration of a first preferred embodiment of an LCD display unit;

FIG. 2 is a flowchart showing the display operation for display information of the first preferred embodiment of an LCD display unit;

FIG. 3 is an outline figure showing successive horizontal scrolls of the full text of display information according to the first preferred embodiment of an LCD display unit;

FIG. 4 is an outline figure showing successive vertical scrolls of the full text of display information according to a second preferred embodiment of an LCD display unit;

FIG. 5 is a flowchart showing the display operation for display information for the second preferred embodiment of an LCD display unit;

FIG. 6 is an outline figure showing successive horizontal scrolls of the full text of display information based upon the operation of a direction key according to a third preferred embodiment of an LCD display unit;

FIG. 7 is a flowchart showing the display operation for display information for the third preferred embodiment of an LCD display unit;

FIG. 8 is an outline figure showing successive horizontal scrolls of the full text of display information at double height and width according to a fourth preferred embodiment of an LCD display unit; and

FIG. 9 is a flowchart showing the display operation for display information for the fourth preferred embodiment of an LCD display unit.

### DETAILED DESCRIPTION OF THE PREFERRED EMBODIMENTS

The following is an explanation of the preferred embodiments of the LCD display unit according to the present invention, referring to the drawings.

### First Preferred Embodiment

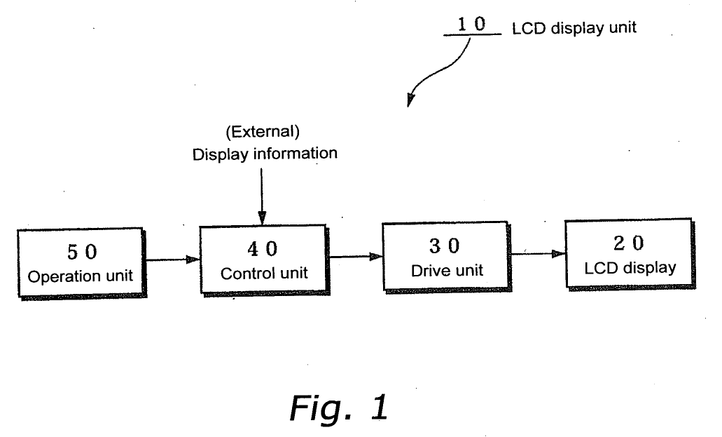

First, a first embodiment of the LCD display unit according to the present invention will be explained with reference to FIG. 1.

FIG. 1 is a block diagram showing the main configuration of an LCD display unit according to this preferred embodiment.

As shown in FIG. 1, an LCD display unit 10 includes an LCD display 20, a drive unit 30, a control unit 40, and an operation unit 50.

The LCD display (LCD display means) 20 can be a conventional commonly known arbitrary suitable LCD display, capable of displaying a predetermined number of characters, symbols, diagrams, and images, etc., in a predetermined number of segments.

The LCD display 20 could have for example 21 character segments, and for example 16 actual segments (display range) for displaying characters, symbols, etc.,

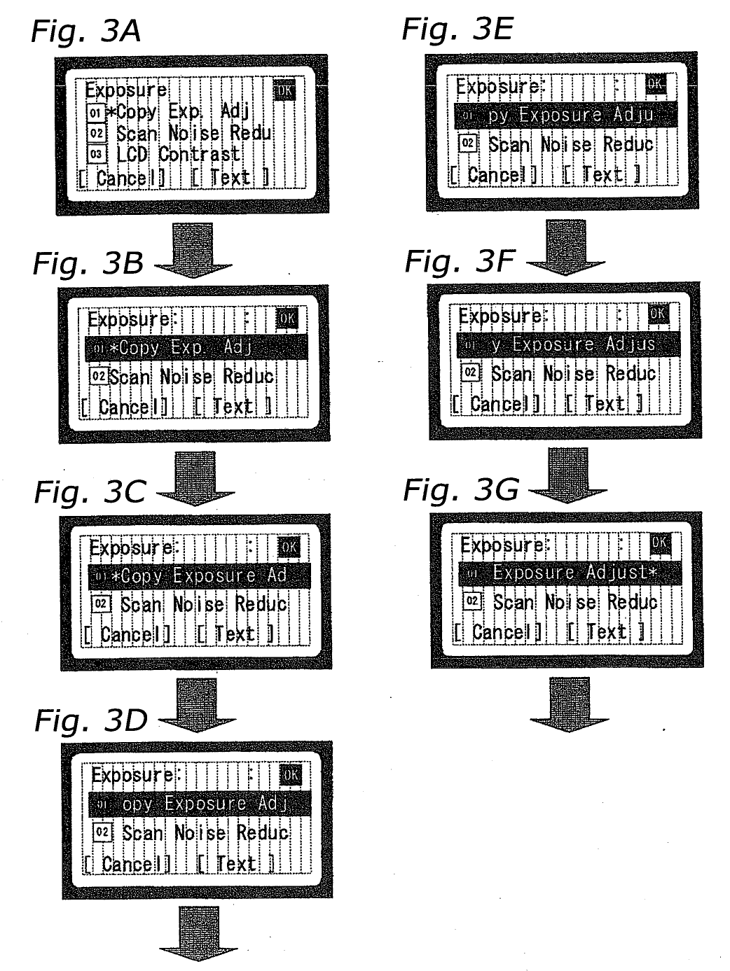

In FIG. 3 each segment in the LCD display 20 has 5 rows in the vertical direction for displaying characters.

Here, the LCD display 20 can display characters in each segment by a dot matrix display. Also, the LCD display 20 can display characters magnified by a specific multiple (for example, double height and width characters) in both vertical and horizontal directions.

The drive unit (drive means) 30 can be a conventional arbitrary suitable drive unit, so that arbitrary characters, symbols, etc., can be displayed in each segment by driving the LCD display 20.

The control unit (control means)+Q acquires function information such as operational status, setting items, fault displays, and maintenance requests from external control means (not shown in the drawings), for example copiers, printers, facsimile machines, and similar. Also the control unit 40 controls the drive unit 30, to display the content of the function information in each segment of the LCD display 20, either in abbreviated text form or full text form.

Normally the control unit 40 displays the display information in abbreviated text form. Also, when clearly selected by a user using the operation unit 50 which is described later, after a predetermined amount of time has passed (for example a few seconds) the display information is displayed in full text form, based upon the selection information from the operation unit 50.

Both the abbreviated text form (abbreviated display) and the full text form (full text display) of the display information are recorded in recording means (not shown on the drawings). In other words, the recording means records a table of the corresponding display forms for both abbreviated text and full text for each item of display information.

For example, in the case of “Copy Exposure Adjustment”, if the abbreviated text form is “Copy Exp. Adj.” and the full text form is “Copy Exposure Adjustment”, these are recorded in a display form table in the recording means so that they are mutually corresponding.

Then when the control unit 40 displays the display information “Copy Exposure Adjustment” in the LCD display 20, normally the abbreviated form “Copy Exp. Adj.” is called up from the recording means and the drive unit 30 controls the LCD display 20 to display the abbreviated text form. On the other hand, if “Copy Exp. Adj.” is selected from the operation unit 50, the full text form “Copy Exposure Adjustment” is called up from the recording means and the drive unit 30 controls the LCD display 20 to display the full text form.

Also, when the control unit 40 is displaying the full text form of the display information, if the number of characters in the full text of the display information is the same or fewer than the number of segments, 16, in the LCD display 20, the full text of the display information is normally displayed. If the number of characters in the full text of the display information is greater than the number of segments as stated above, an identification symbol, for example “*” is added to the start and end of the text, and the LCD display 20 is driven and controlled by the drive unit 30 to scroll the text in the LCD display 20.

By placing the operation unit (operation means) 50 adjacent to the LCD display 20 for example, the display information displayed on the LCD 20 in abbreviated text form can be selected by a user operating an operation key.

The operation unit 50 can be a different form from the LCD display 20, or the operation unit 50 can be integral with the LCD display 20. An example where the operation unit 50 is integral with the LCD display 20 is a touch panel.

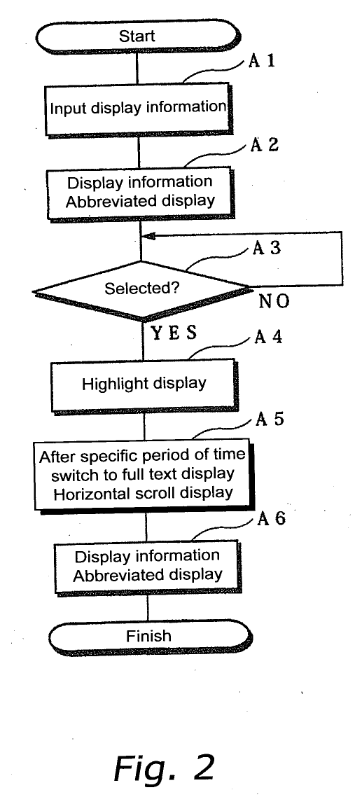

Next, the LCD display unit 10 according to the first preferred embodiment will be explained with reference to FIG. 2.

FIG. 2 is a flowchart showing the display operation for display information for an LCD display unit 10.

Referring to FIG. 2, as indicated by symbol A1, first display information is input from each equipment to the control unit 40 with each equipment in the static state. Then, as indicated by symbol A2, the control unit 40 displays the abbreviated text form of the display information on the LCD display 20 using the drive unit 30.

Then, as shown in FIG. 3(A), for example three adjustment items are displayed regarding exposure: the first item “Copy Exp. Adj.” (Copy Exposure Adjustment), the second item “Scan Noise Reduc” (Scan Noise Reduction), and the third item “LCD Contrast”.

In this case, the cursor is set at the first item, and the identification symbol “*” is added to the front of the text.

The cursor can be moved in the vertical direction using the cursor key of the operation unit 50, and as the cursor moves the identification symbol “*” also moves.

Here, when the user selects the first item at which the cursor is aligned using the operation keys of the operation unit 50 as shown at symbol A3, the control means 50 displays the first item highlighted as shown in FIG. 3(B) and as indicated by symbol A4. In addition, the display information items are displayed in two rows. From here on the display of the third item is suspended.

Then the control unit 40, after a predetermined period of time, switches the first item to full text display, as indicated by symbol A5, displaying for example “*Copy Exposure Adjustment*”.

In this case the number of the characters in the full text display exceeds the 16 character capacity of the LCD display 20, so the control unit 40 displays only the front of the full text as shown in FIG. 3(C). Then after scrolling the display as shown in FIG. 3(D) to FIG. 3(G), the abbreviated form of the first item (see FIG. 3(B)) is displayed again, as indicated by symbol A6.

This completes the horizontal scrolling of the full text display of the display information by the LCD display unit 10.

### Second Preferred Embodiment

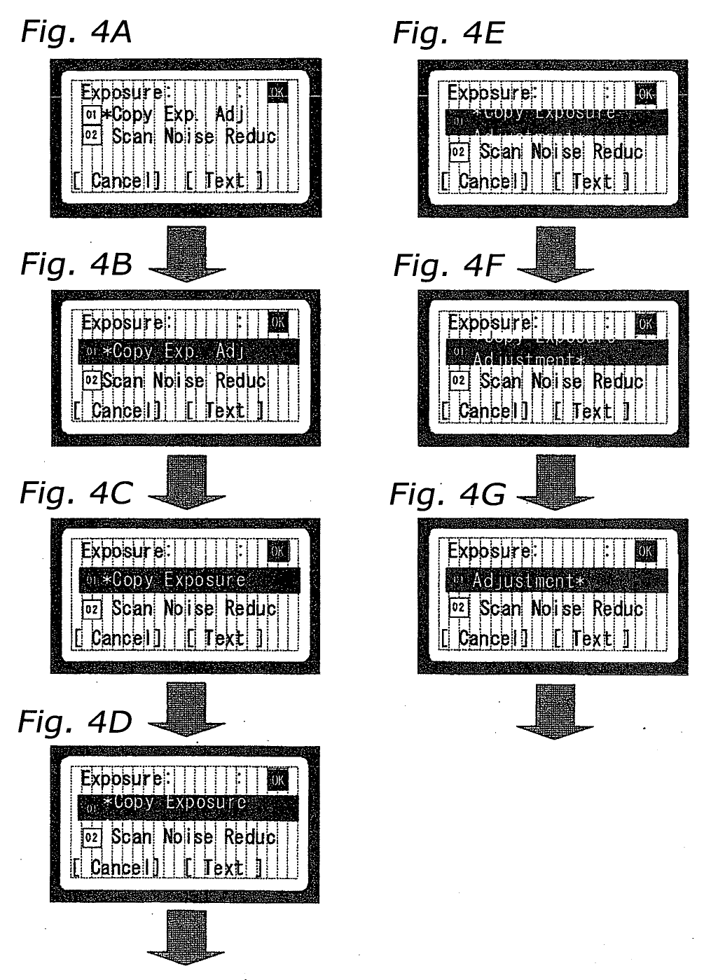

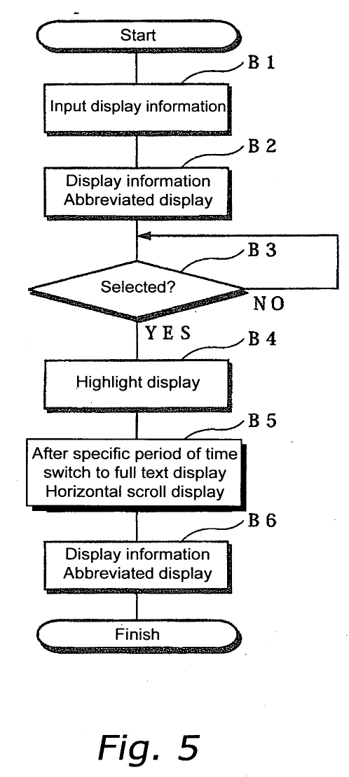

Next, a second preferred embodiment of the LCD display unit will be explained with reference to FIG. 4 and FIG. 5. FIG. 4 and FIG. 5 show the display information scrolling state and operation of the second embodiment of the LCD display unit according to the present invention.

In the second preferred embodiment the LCD display unit is the same type as the LCD display unit according to the first preferred embodiment shown in FIG. 1, and differs only in that when the control unit 40 displays the full text display of the selected display information, the display is scrolled in the vertical direction, as shown successively in FIG. 4.

Next, the operation of the LCD display unit of the second preferred embodiment will be explained with reference to FIG. 5.

FIG. 5 is a flowchart showing the display operation for display information for an LCD display unit according to the second preferred embodiment.

First as indicated by symbol B1, display information is input from each equipment to the control unit 40. Then, as indicated by symbol B2, the control unit 40 displays the abbreviated text form of the display information on the LCD display 20 using the drive unit 30.

Then, as shown in FIG. 4(A), for example two adjustment items are displayed regarding exposure: the first item “Copy Exp. Adj.” (Copy Exposure Adjustment), and the second item “Scan Noise Reduc” (Scan Noise Reduction).

In this case, the cursor is set at the first item, and the identification symbol “*” is added to the front of the text.

The cursor can be moved in the vertical direction using the cursor key of the operation unit 50, and as the cursor moves the identification symbol “*” also moves.

Here, when the user selects the first item at which the cursor is aligned using the operation keys of the operation unit 50 as indicated at symbol B3, the control means 50 displays the first item highlighted as shown in FIG. 4(B) and as indicated by symbol B4. Then the control unit 40, after a predetermined period of time, switches the first item to full text display, as indicated by symbol B5, displaying for example “*Copy Exposure Adjustment*”.

In this case the number of the characters in the full text display exceeds the 16 character capacity of the LCD display 20, so the control unit 40 displays only the front of the full text “*Copy Exposure” as shown in FIG. 4(C). The next text “Adjustment*” is displayed on a second line, but nothing is displayed after the second line.

Then as shown in FIG. 4(D) to FIG. 4(G), the display is scrolled by the control unit 40, and after the second line is displayed the abbreviated form of the first item (see FIG. 4(B)) is displayed again, as indicated by symbol B6.

This completes the vertical scrolling of the full text display of the display information by the LCD display unit.

### Third Preferred Embodiment

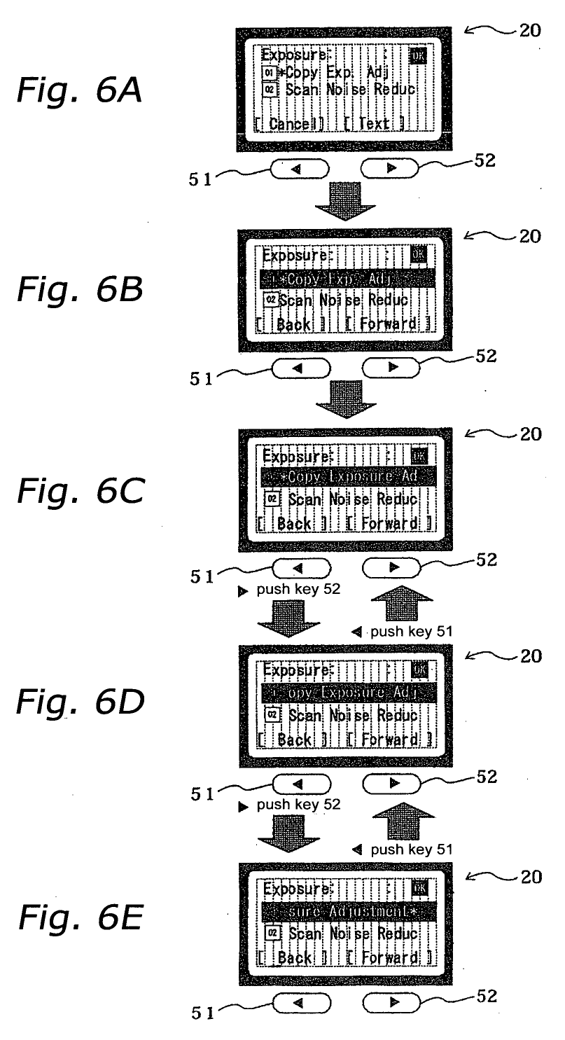

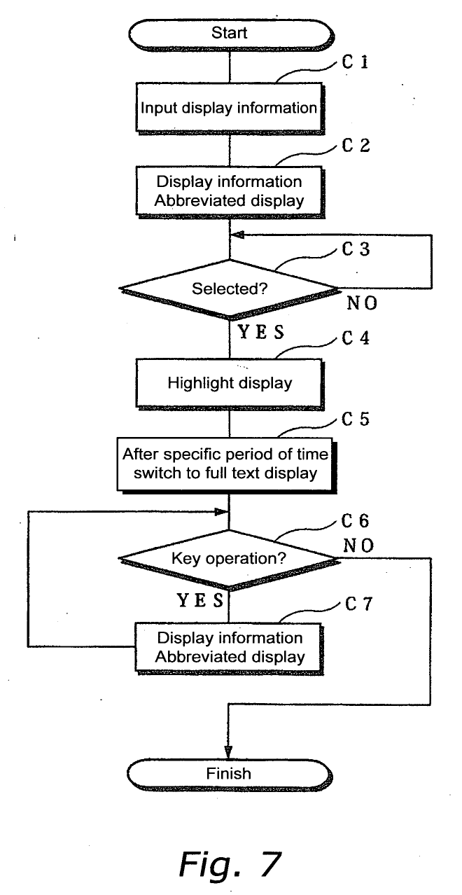

Next, a third preferred embodiment of the LCD display unit according to the present invention will be explained with reference to FIG. 6 and FIG. 7.

FIG. 6 and FIG. 7 show the display information scrolling state and operation of the third embodiment of the LCD display unit according to the present invention.

In the third preferred embodiment the LCD display unit is the same type as the LCD display unit according to the first preferred embodiment shown in FIG. 1. The third preferred embodiment differs from the first preferred embodiment only in that the operation unit 50 includes direction keys 51, 52 located beside the LCD display 20 as shown in FIG. 6, and when the control unit 40 displays the selected display information as full text, the display is scrolled in the horizontal direction in accordance with the operation of the direction keys 51, 52.

Here, when the direction keys 51, 52 are operated for less than a predetermined period of time, the control unit 40 controls the drive unit 30 to move the full text of the display information in the LCD display 20 one character at a time either to the left or to the right as shown successively in FIG. 6.

Next, the operation of the LCD display unit of the third preferred embodiment will be explained with reference to FIG. 7.

FIG. 7 is a flowchart showing the display operation for display information for an LCD display unit according to the third preferred embodiment.

First, as indicated by symbol C1, display information is input from each equipment to the control unit 40. Then, as indicated by symbol C2, the control unit 40 displays the abbreviated text form of the display information on the LCD display 20 using the drive unit 30.

Then, as shown in FIG. 6(A), for example two adjustment items are displayed regarding exposure: the first item “Copy Exp. Adj.” (Copy Exposure Adjustment), and the second item “Scan Noise Reduc” (Scan Noise Reduction).

In this case, the cursor is set at the first item, and the identification symbol “*” is added to the front of the text.

The cursor can be moved in the vertical direction using the cursor key of the operation unit 50, and as the cursor moves the identification symbol “*” also moves.

Here, when the user selects the first item at which the cursor is aligned using the operation keys of the operation unit 50 as indicated at symbol C3, the control means 50 displays the first item highlighted as shown in FIG. 6(B) and as indicated by symbol C4. Then the control unit 40, after a predetermined period of time, switches the first item to full text display, as indicated by symbol C5, displaying for example “*Copy Exposure Adjustment*”.

In this case the number of the characters in the full text display exceeds the 16 character capacity of the LCD display 20, so the control unit 40 displays only the front of the full text “*Copy Exposure” as shown in FIG. 6(C). The next text “Adjustment*” is displayed on a second line, but nothing is displayed after the second line.

Then, as indicated by symbol C6, when the user operates either the direction key 51 or 52 of the operation unit 50 for less than a predetermined period of time, as shown in FIG. 6(C) to FIG. 6(E), the text is scrolled. When the direction key 51 is operated the full text display of the display information is moved to the left one character at a time, and when the direction key 52 is operated the full text display of the display information is moved to the right one character at a time, as indicated by symbol C7.

In the full text display state of the display information as shown in FIG. 6(C), when the user operates for example the direction key 51 of the operation unit 50 for longer than a predetermined period of time, the control unit 40 moves the full text display of the display information automatically to the left one dot at a time to scroll the display.

This completes the vertical scrolling of the full text display of the display information by the LCD display unit.

### Fourth Preferred Embodiment

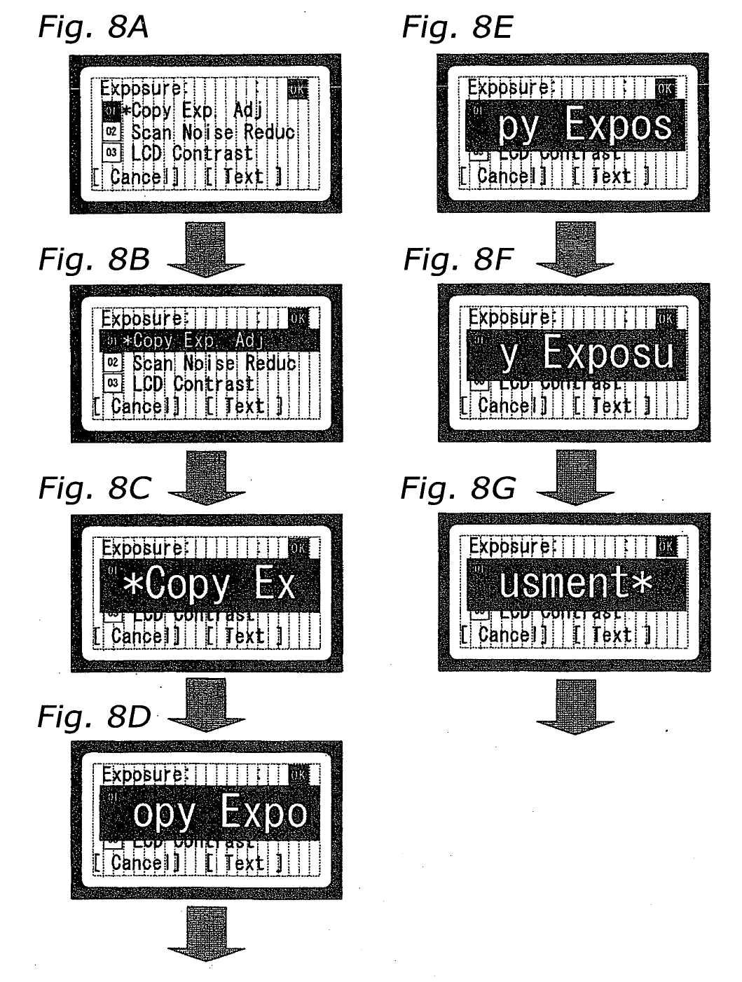

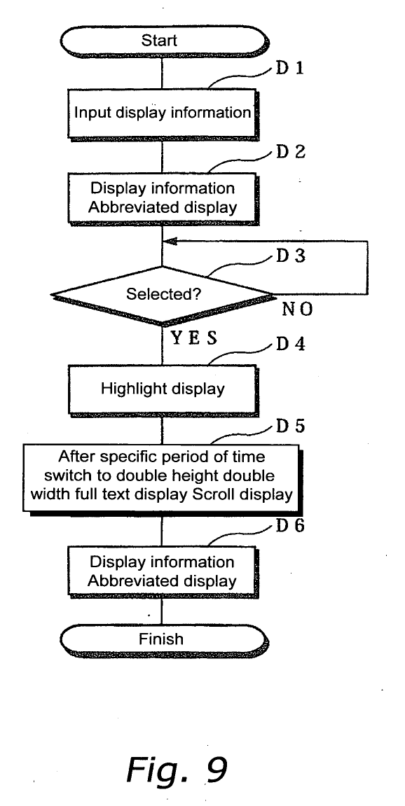

Next, a fourth preferred embodiment of the LCD display unit according to the present invention will be explained with reference to FIG. 8 and FIG. 9.

FIG. 8 and FIG. 9 show the display information scrolling state and operation of a fourth embodiment of the LCD display unit according to the present invention.

In the fourth preferred embodiment the LCD display unit is the same type as the LCD display unit 10 according to the first preferred embodiment shown in FIG. 1. The third preferred embodiment differs from the first preferred embodiment only in that when the control unit 40 displays the selected display information as full text, the display is scrolled in the horizontal direction in double height double width text.

Next, the operation of the LCD display unit of the fourth preferred embodiment will be explained with reference to FIG. 9.

FIG. 9 is a flowchart showing the display operation for display information for an LCD display unit according to the fourth preferred embodiment. First, as indicated by symbol D1, display information is input from each equipment to the control unit 40. Then, as indicated by symbol D2, the control unit 40 displays the abbreviated text form of the display information on the LCD display 20 using the drive unit 30.

Then, as shown in FIG. 8(A), for example three adjustment items are displayed regarding exposure: the first item “Copy Exp. Adj.” (Copy Exposure Adjustment), the second item “Scan Noise Reduc” (Scan Noise Reduction), and the third item “LCD Contrast”.

In this case, the cursor is set at the first item, and the identification symbol “*” is added to the front of the text.

The cursor can be moved in the vertical direction using the cursor key of the operation unit 50, and as the cursor moves the identification symbol “*” also moves.

Here, when the user selects the first item at which the cursor is aligned using the operation keys of the operation unit 50 as indicated at symbol D3, the control means 40 displays the first item highlighted as shown in FIG. 8(B) and as indicated by symbol D4. After a predetermined period of time, the first item is switched to full text display in double height double width, as indicated by symbol D5, displaying for example “*Copy Exposure Adjustment*”.

In this case the number of the characters in the full text display exceeds the 16 character capacity of the LCD display 20, so the control unit 40 displays only the front of the full text “*Copy Ex” as shown in FIG. 8(C).

Then after scrolling the display as shown in FIG. 8(D) to FIG. 8(G), the control unit 40 displays the abbreviated form of the first item (see FIG. 8(B)) again, as indicated by symbol D6.

This completes the horizontal scrolling of the full text display in double height and double width characters of the display information by the LCD display unit.

The above is an explanation of the preferred embodiments of the LCD display unit according to the present invention. However, the LCD display unit according to the present invention is not limited to the above preferred embodiments, and it will be clear to one skilled in the art that many variations are possible in the present invention.

For example, in each of the above preferred embodiments the display area of the LCD display 20 contains 16 segments to display 16 characters. However, it is clear that the present invention is not limited to this, and display area may contain a different numbers of segments.

Also, in the above preferred embodiments when display information is selected it is displayed as highlighted. However, the present invention is not limited to this, and a color display could change colors, or there may be no change in the display.

Furthermore, in the above preferred embodiments, when the control unit 40 displays the full text of display information, the display is scrolled. However, when the number of characters in the full text display is equal to or fewer than the number of characters that the LCD display 20 can display, 16, the text need not be scrolled, but may be displayed as a static display.

Also, in the above preferred embodiments, when the control unit 40 displays the full text display of the display information, an identification symbol “*” is added to the front and end of the text. However, the present invention is not limited to this, and provided the front and end of the text can be easily identified another identification symbol may be used.

In this way, according to the present invention an LCD display unit can be provided capable of displaying the full text of display information having a greater number of characters than can be displayed.

The present invention is related to the control of information display in LCD display units, so it can be used in equipment and devices containing LCD display units.

What is claimed is:

1. An LCD display unit, comprising:
LCD display means having a predetermined number of segments;
drive means that drives the LCD display means;
control means that controls the drive means to display one or a plurality of display information on the LCD display means; and
operation means for selecting part or all of the one or a plurality of display information displayed on the LCD display means,
wherein the control means normally displays a part or all of the one or a plurality of display information in an abbreviated form on the LCD display means; when the above display information is selected based upon operation of the operation means the selected display information is displayed in full text form on the LCD display means; and when the length of the character string of the display information displayed in full text form exceeds the display range of the LCD display means the display information is displayed as scrolled.

2. The LCD display unit according to claim 1, wherein when the length of the character string of the display information displayed in full text form exceeds the display range of the LCD display means, the control means scrolls the display information after a predetermined period of time has passed after selecting the display information based upon operation of the operation means.

3. The LCD display unit according to claim 1, wherein an identification symbol is added to the front and/or back of the display information being scrolled.

4. The LCD display unit according to claim 1, wherein when the display information is being scrolled, each character of the display information is enlarged in the vertical and/or horizontal direction by a predetermined factor.

5. The LCD display unit according to claim 1, wherein when the display information is being scrolled, the control means scrolls the full text of the display information to the left by a predetermined number of dots at a time in each segment of the LCD display means.

6. The LCD display unit according to claim 1, wherein when the display information is being scrolled, the control means scrolls the full text of the display information upwards by a predetermined number of dots at a time in each segment of the LCD display means.

7. The LCD display unit according to claim 1, further comprising direction keys to specify the direction for scrolling the display information, wherein the control means scrolls the display information based upon the direction specified by the direction keys.

8. The LCD display unit according to claim 7, wherein when the operation time of a direction key is less than a predetermined period of time, the control means scrolls the full text of the display information one character at a time in the direction specified by the direction key.

9. The LCD display unit according to claim 7, wherein when the operation time of a direction key is longer than a predetermined period of time, the control means scrolls the full text of the display information continuously in the direction specified by the direction key.
